(19) United States
(12) Patent Application Publication
(10) Pub. No.: US 2016/0190551 A1
(43) Pub. Date: Jun. 30, 2016

(54) MIXED ACTIVE MATERIAL FOR LITHIUM SECONDARY BATTERY, LITHIUM SECONDARY BATTERY ELECTRODE, LITHIUM SECONDARY BATTERY AND POWER STORAGE APPARATUS

(71) Applicant: GS YUASA INTERNATIONAL LTD., Kyoto (JP)

(72) Inventor: Daisuke ENDO, Kyoto (JP)

(21) Appl. No.: 14/903,483

(22) PCT Filed: Jun. 18, 2014
(86) PCT No.: PCT/JP2014/003271

§ 371 Date: Jan. 7, 2016

(30) Foreign Application Priority Data
Jul. 10, 2013 (JP) 2013-144210
Jan. 8, 2014 (JP) 2014-001743

(51) Int. Cl. H01M 4/36; H01M 4/505; H01M 10/052; H01M 4/525

(52) U.S. Cl. CPC H01M 4/364; H01M 4/525; H01M 4/505; H01M 10/052; H01M 2004/028

(57) ABSTRACT

Provided is a mixed active material for a lithium secondary battery, which includes a lithium transition metal composite oxide having an α-NaFeO₂ structure with the transition metal (Me) including Co, Ni and Mn and the Mn/Me molar ratio being more than 0.5, and a lithium transition metal composite oxide having an α-NaFeO₂ structure with the transition metal (Me) including Co, Ni and Mn and the Mn/Me molar ratio being more than 0 and not more than 0.5, wherein the mixed active material has a specific surface area of 4.4 m²/g or less and a S content of 0.2 to 1.2% by mass.

### TECHNICAL FIELD

The present invention relates to a mixed active material for a lithium secondary battery, a lithium secondary battery electrode including the mixed active material, a lithium secondary battery including the electrode, and a power storage apparatus including the battery.

### BACKGROUND ART

Currently, nonaqueous electrolyte secondary batteries represented by lithium ion secondary batteries, particularly lithium secondary batteries are widely used in portable terminals etc. For these nonaqueous electrolyte secondary batteries, LiCoO₂ is mainly used as a positive active material. However, the discharge capacity of LiCoO₂ is only about 120 to 130 mAh/g.

As a material of a positive active material for a lithium secondary battery, a solid solution of LiCoO₂ and other compounds is known. Li[Co₁₋₂ₓNiₓMnₓ]O₂ (0<x≦½), which has an α-NaFeO₂-type crystal structure and which is a solid solution of three components: LiCoO₂, LiNiO₂ and LiMnO₂, was published in 2001. LiNi_{1/2}Mn_{1/2}O₂ or LiCo_{1/3}Ni_{1/3}Mn_{1/3}O₂ that is one example of the above-mentioned solid solution has a discharge capacity of 150 to 180 mAh/g, and is also excellent in charge-discharge cycle performance.

In contrast with so called a “LiMeO₂-type” active material as described above, so called a “lithium-excess-type” positive active material is known in which the composition ratio of lithium (Li) to a transition metal (Me) (Li/Me) is greater than 1, with Li/Me being, for example, 1.25 to 1.6 (see, for example, Patent Documents 1 and 2). Such a material can be expressed as Li_{1+α}Me_{1-α}O₂ (α>0). Here, β=(1+α)/(1−α) when the composition ratio of lithium (Li) to a transition metal (Me) (Li/Me) is 3, and therefore, for example, α=0.2 when Li/Me is 1.5.

Patent Documents 1 and 2 describe active materials as described above. These patent documents describe a method for producing a battery using the above-described active material in which a process is provided that performs charging at least to a region with a relatively small potential change, which emerges in a positive electrode potential range of more than 4.3 V (vs. Li/Li⁺) and no more than 4.8 V (vs. Li/Li⁺). With this, a battery having a discharge capacity of 200 mAh/g or more can be produced even when a charge method is employed in which the maximum ultimate potential of a positive electrode during charging is 4.3 V (vs. Li/Li⁺) or less, or less than 4.4 V (vs. Li/Li⁺) in use of the battery.

Patent Document 3 describes the invention of “a method for producing a positive active material in which a positive active material is prepared from a lithium-containing oxide, the method including the step of treating the lithium-containing oxide in an acidic aqueous solution, the lithium-containing oxide containing Li₁₊ₓ(Mn_{y}M_{1-y})₁₋ₓO₂(0<x<0.4, 0<y≦1) where M includes at least one transition metal other than manganese, the acidic aqueous solution having a hydrogen ion content of not less than x mol and less than 5× mol based on 1 mol of the lithium-containing oxide” (claim 5). Also, Patent Document 3 indicates that an object of the invention is to provide “a high-capacity positive active material capable of ensuring that a nonaqueous electrolyte secondary battery has excellent load characteristics and high initial charge-discharge efficiency; and a method for producing the positive active material” (paragraph [0009]).

Patent Document 4 describes the invention of “a method for producing a positive active material for a lithium ion secondary battery, the method including: an acid-treating step of bringing an acid solution into contact with an active material represented by the composition formula: xLi₂M¹O₃.(1−x)LiM²O₂ (M¹ represents at least one metal element including tetravalent manganese as an essential component, M² represents at least one metal element, 0<x≦1, and Li may be partially substituted with hydrogen); and a lithium supply step of bringing a lithium compound-containing lithium solution into contact with the acid-treated active material” (claim 1). Also. Patent Document 4 describes “the method for producing a positive active material for a lithium ion secondary battery according to claim 1, wherein the acid solution includes at least one of a sulfuric acid aqueous solution, a nitric acid aqueous solution and an ammonium aqueous solution” (claim 2). Patent Document 4 indicates that an object of the invention is to provide “a method for producing a positive active material for a lithium ion secondary battery, which is capable of suppressing a reduction in battery capacity due to activation of a positive active material” (paragraph [0011]).

Patent Document 5 describes the invention of “the positive active material for a lithium ion secondary battery according to claim 1 or 2, wherein the positive active material is obtained by immersing a laminar transition metal oxide having a crystal structure belonging to space group C2/m represented by the general formula (2): Li_{2-0.5x}Mn₁₋ₓM_{1.5}O₃ . . . (2) (where Li represents lithium, Mn represents manganese, M represents Ni_{α}Co_{β}Mn_{γ}(where Ni represents nickel, Co represents cobalt, Mn represents manganese, and α, β and γ satisfy 0<α≦0.5, 0≦β≦0.33 and 0<γ≦0.5), and x satisfies the relationship of 0<x<1.00) in an acidic solution” (claim 3). Also, Patent Document 5 indicates that an object of the invention is to provide “a positive active material for a lithium ion secondary battery, which is capable of exhibiting excellent initial charge-discharge efficiency, a lithium ion secondary battery positive electrode produced using the positive active material, and a lithium ion secondary battery” (paragraph [0008]).

Patent Document 6 describes the invention of “a lithium transition metal-based compound powder for a lithium secondary battery positive electrode material, wherein the lithium transition metal-based compound powder is an oxide represented by the general formula (1), and has Li pores and oxygen pores in the crystal structure, and the root mean square surface roughness (RMS) of the surfaces of primary particles as specified in JIS B 0601:2001 is 1.5 nm or less: xLi₂MO₃.(1−x)LiNO₂ . . . (1) (where x represents a number satisfying 0<x<1, M represents at least one metal element having an average oxidation number of 4⁺, and N represents a metal element having an average oxidation number of 3⁺)” (claim 1), and “the lithium transition metal-based compound powder for a lithium secondary battery positive electrode material according to claim 1, wherein the lithium transition metal-based compound powder includes a compound produced by performing a heating treatment in a solvent with a pH³ of 5, followed by a heat treatment at a temperature of not lower than 200° C. and not higher than 900° C. for 24 hours or less” (claim 2). Also. Patent Document 6 indicates that an object of the invention is to provide “a lithium secondary battery positive electrode material capable of providing a lithium secondary battery having high initial efficiency and excellent rate characteristics, a lithium secondary battery positive electrode, and a lithium secondary battery produced with the use thereof” (paragraph [0010]).

Patent Document 7 describes “a nonaqueous electrolyte secondary battery including a positive electrode, a negative electrode, a separator and a nonaqueous electrolyte, wherein the positive electrode contains at least one positive active material selected from a first positive active material and a second positive active material, the first positive active material is represented by the general composition formula: Li_{(i+α)}MnₓNi_{y}Co_{(1-x-y-z)}M_{z}O₂ (where M represents at least one element selected from the group consisting of Ti, Zr, Nb, Mo, W, Al, Si, Ga, Ge and Sn, −0.15<a<0.15, 0.1<x≦0.5, 0.6<x+y+z<1.0 and 0≦z≦0.1), the second positive active material is represented by the general composition formula: Li_{(1-s-b)}MgₛCo₍₁₋ₜ₋ᵤ₎Al₁M′ᵤO₂ (where M′ represents at least one element selected from the group consisting of Ti, Zr and Ge, 0.01≦s<0.1, 0<u<0.1, 0.01<t+u<0.1 and −0.06≦b<0.05), a compound having a bond represented by —SOₙ— (1≦n≦4) exists on the surface of the positive electrode, and the content of sulfur existing on the surface of the positive electrode as the bond represented by —SOₙ— (1≦n≦4) is not less than 0.2 atom % and not more than 1.5 atom % as measured by X-ray photoelectron spectroscopy” (claim 1). Also, Patent Document 7 indicates that an object of the invention is to provide “a nonaqueous electrolyte secondary battery which has an increased capacity when charged at a high voltage and which is excellent in cycle performance and storage characteristics” (paragraph [0011]).

### PRIOR ART DOCUMENTS

### Patent Documents

Patent Document 1: WO2012/091015

Patent Document 2: WO2013/084923

Patent Document 3: JP-A-2009-004285

Patent Document 4: JP-A-2012-195082

Patent Document 5: JP-A-2012-185913

Patent Document 6: JP-A-2012-234772

Patent Document 7: JP-A-2008-270086

### DISCLOSURE OF THE INVENTION

### Problems to be Solved by the Invention

This specification discloses a technique for providing a mixed active material for a lithium secondary battery, which improves both the battery capacity and cycle performance, an electrode and a lithium secondary battery with the mixed active material.

### Means for Solving the Problems

The embodiment of the present invention provides a mixed active material for a lithium secondary battery, which includes a lithium transition metal composite oxide having an α-NaFeO₂ structure with the transition metal (Me) including Co, Ni and Mn and the Mn/Me molar ratio being more than 0.5, and a lithium transition metal composite oxide with the transition metal (Me) including Co, Ni and Mn and the Mn/Me molar ratio being more than 0 and not more than 0.5, wherein the mixed active material has a specific surface area of 4.4 m²/g or less and a S content of 0.2 to 1.2% by mass.

The embodiment can also be implemented as a lithium secondary battery electrode containing the mixed active material for a lithium secondary battery.

The embodiment can also be implemented as a lithium secondary battery including the lithium secondary battery electrode.

The embodiment can also be implemented as a power storage apparatus including a plurality of lithium secondary batteries.

### Advantages of the Invention

According to this embodiment, there can be provided a mixed active material for a lithium secondary battery, which improves both the battery capacity and cycle performance, an electrode and a lithium secondary battery with the mixed active material.

### BRIEF DESCRIPTION OF THE DRAWINGS

FIG. 1 is a schematic view showing a power storage apparatus including a plurality of lithium secondary batteries according to the embodiment.

### MODE FOR CARRYING OUT THE INVENTION

It is known that in the conventional technique described above, a “lithium-excess-type” positive active material is acid-treated to remove a part of Li, so that initial efficiency is improved, and also the capacity, cycle performance and so on are improved. However, the conventional technique has a disadvantage in preparation of an electrode due to a considerable increase in specific surface area. It has become apparent that the conventional technique also has the problem that cycle performance is deteriorated although initial efficiency and the capacity are improved as indicated below in comparative examples.

Further, it has become apparent that a “LiMeO₂-type” positive active material does not undergo a significant increase in specific surface area when acid-treated as compared to a “lithium-excess-type” positive active material, but the capacity, cycle performance and so on are not improved.

The constitution and the effect of the present invention will be described along with technical concepts. However, the action mechanism includes assumptions, and propriety thereof does not limit the present invention. The present invention may be carried out in various other modes without departing from the spirit of principal featured of the present invention. Therefore, an embodiment in this specification is merely illustrative in every aspect, and should not be restrictively construed. Further, modifications and changes belonging to equivalents of claims all fall within the present invention.

In the embodiment, the following techniques are employed for achieving the object described above.

The embodiment provides a mixed active material for a lithium secondary battery, which includes a lithium transition metal composite oxide having an α-NaFeO₂ structure with the transition metal (Me) including Co, Ni and Mn and the Mn/Me molar ratio being more than 0.5, and a lithium transition metal composite oxide having an α-NaFeO₂ structure with the transition metal (Me) including Co, Ni and Mn and the Mn/Me molar ratio being more than 0 and not more than 0.5, the mixed active material having a specific surface area of 4.4 m²/g or less and a S content of 0.2 to 1.2% by mass.

It has become apparent that the lithium transition metal composite oxide having an α-NaFeO₂ structure with the transition metal (Me) including Co, Ni and Mn and the Mn/Me molar ratio being more than 0.5 (hereinafter, referred to as a “lithium-excess-type lithium transition metal composite oxide”) undergoes an increase in specific surface area as described above when acid-treated is performed, while the lithium transition metal composite oxide with the transition metal (Me) including Co, Ni and Mn and the Mn/Me molar ratio being more than 0 and not more than 0.5 (hereinafter, referred to as a “LiMeO₂-type lithium transition metal composite oxide”) does not undergo a significant increase in specific surface area when acid-treated as compared to the lithium-excess-type lithium transition metal composite oxide.

Thus, in the embodiment, S may be incorporated by acid-treating the lithium transition metal composite oxide with the transition metal (Me) including Co, Ni and Mn and the Mn/Me molar ratio being more than 0 and not more than 0.5. Preferably, the acid-treated LiMeO₂-type lithium transition metal composite oxide is mixed with the lithium-excess-type lithium transition metal composite oxide for improving both the battery capacity and cycle performance while suppressing an increase in specific surface area. The mixing ratio of the lithium-excess-type lithium transition metal composite oxide and the acid-treated LiMeO₂-type lithium transition metal composite oxide is preferably 70:30 to 95:5, more preferably 80:20 to 90:10.

In the embodiment, the specific surface area of the mixed active material of the lithium-excess-type lithium transition metal composite oxide and the LiMeO₂-type lithium transition metal composite oxide is 4.4 m²/g or less for improving cycle performance. The specific surface area is preferably 4.2 m²/g or less, more preferably 3.8 m²/g or less.

Preferably, S is incorporated in the positive active material by acid-treating the LiMeO₂-type lithium transition metal composite oxide with sulfuric acid. When the lithium-excess-type lithium transition metal composite oxide is acid-treated, the specific surface area is excessively increased. In the embodiment, the content of S is 0.2 to 1.2% by mass, preferably 0.2 to 1.0% by mass, more preferably 0.2 to 0.8% by mass for improving the battery capacity and cycle performance.

The lithium-excess-type lithium transition metal composite oxide is typically represented by the composition formula Li₁₊₊M_{1-α}O₂ (where Me represents a transition metal element including Co, Ni and Mn, (1+α)/(1−α)>1.2, and Mn/Me molar ratio>0.5). The LiMeO₂-type lithium transition metal composite oxide is typically represented by the composition formula LiₓMeO₂ (where Me represents a transition metal element including Co, Ni and Mn, x≦1.2, and 0<Mn/Me molar ratio≦60.5).

In the embodiment, the molar ratio of Li to the transition metal element Me (Li/Me) is represented by (1+α)/(1−α) when the lithium transition metal composite oxide with the transition metal (Me) including Co, Ni and Mn and the Mn/Me molar ratio being more than 0.5 is represented by the composition formula Li_{1+α}Me_{1-α}O₂. The Li/Me molar ratio may be more than 1. When the Li/Me molar ratio is more than 1.2 (α=0.09) and less than 1.6 (α=0.23), a lithium secondary battery having a high discharge capacity (battery capacity) and excellent cycle performance and high rate discharge performance can be obtained. Thus, (1+α)/(1−α) is preferably more than 1.2 and less than 1.6. In particular, the Li/Me ratio ((1+α)/(1−α)) is more preferably not less than 1.25 and not more than 1.5 because a lithium secondary battery having a particularly high discharge capacity and excellent cycle performance and high rate discharge performance can be obtained.

In the embodiment, the molar ratio of Co to the transition metal element Me (Co/Me) in the lithium-excess-type lithium transition metal composite oxide is preferably 0.05 to 0.40, more preferably 0.10 to 0.30 because a lithium secondary battery having a high discharge capacity and excellent initial efficiency and cycle performance can be obtained.

The molar ratio of Mn to the transition metal element Me (Mn/Me) in the lithium-excess-type lithium transition metal composite oxide is more than 0.5 for obtaining a lithium secondary battery having a high discharge capacity and excellent high rate discharge performance and cycle performance. The LiMeO₂-type lithium transition metal composite oxide, when having a Mn/Me molar ratio of more than 0.5, no longer retains a structure belonging to an α-NaFeO₂ structure due to occurrence of spinel transition when the battery is charged. Thus, the LiMeO₂-type lithium transition metal composite oxide is not suitable as an active material for a lithium secondary battery. On the other hand, the lithium-excess-type lithium transition metal composite oxide, even when having a Mn/Me molar ratio of more than 0.5, can retain an α-NaFeO₂ structure when the battery is charged. Therefore, the configuration in which the Mn/Me molar ratio is more than 0.5 characterizes a positive active material formed of a so-called lithium-excess-type lithium transition metal composite oxide. The Mn/Me molar ratio (Mn/Me) is preferably more than 0.5 and not more than 0.8, more preferably more than 0.5 and not more than 0.75.

The lithium-excess-type lithium transition metal composite oxide according to the embodiment is a composite oxide represented by the general formula: Li_{1+α}(CoₐNi_{b}Mn_{c})_{1-α}O₂ (where α>0, a+b+c=1, α>0, b>0 and c>0) and principally composed of Li, Co, Ni and Mn, but it is preferable to include Na in an amount of 1000 ppm or more for improving the discharge capacity. The content of Na is more preferably 2000 to 10000 ppm.

For incorporating Na, a method can be employed in which a sodium compound such as sodium hydroxide or sodium carbonate is used as a neutralizing agent in a step of preparing a hydroxide precursor or a carbonate precursor as described later, and Na is left in a washing step, or a sodium compound such as sodium carbonate is added in a subsequent firing step.

Inclusion of a small amount of other metals such as alkali metals other than Na, and alkali earth metals such as Mg and Ca and transition metals represented by 3d transition metals such as Fe and Zn is not excluded as long as the effect of the present invention is not impaired.

The lithium-excess-type lithium transition metal composite oxide according to the embodiment has an α-NaFeO₂ structure. The lithium transition metal composite oxide after synthesis (before charge-discharge is performed) belongs to space group P3₁12 or R3-m. The lithium transition metal composite oxide belonging to space group P3₁12 has an super-lattice peak (a peak found in the Li[Li_{1/3}Mn_{2/3}]O₂-type monoclinic crystal) around 2θ=21° on an X-ray diffraction pattern obtained using a CuKα tubular bulb. However, when the battery is charged even once, resulting in desorption of Li in the crystal, the symmetry of the crystal is changed, so that the super-lattice peak disappears, and thus the lithium transition metal composite oxide comes to belong to space group R3-m. Here, P3₁12 is a crystal structure model in which atom positions at 3a, 3b and 6c sites in R3-m are subdivided, and the P3₁12 model is employed when there is orderliness in atom arrangement in R3-m. Properly, “R3-m” should be written with a bar “-” added above “3” of “R3m”.

In the lithium-excess-type lithium transition metal composite oxide according to the embodiment, the half-width of a diffraction peak belonging to the (003) plane when space group R3-m is used as a crystal structure model based on an x-ray diffraction pattern is preferably in the range of 0.18° to 0.22°. Accordingly, the discharge capacity of the positive active material can be increased, and high rate discharge performance can be improved. The diffraction peak at 2θ=18.6°±1°, which appears when a CuKα tubular bulb is used is indexed to the (003) plane in the mirror index hkl for space groups P3₁12 and R3-m.

Preferably, the lithium-excess-type lithium transition metal composite oxide does not undergo a structural change in overcharge. This can be confirmed when the lithium-excess-type lithium transition metal composite oxide is observed as a single phase belonging to space group R3-m on an X-ray diffraction pattern when it is electrochemically oxidized to a potential of 5.0 V (vs. Li/Li⁺). Accordingly, a lithium secondary battery excellent in charge-discharge cycle performance can be obtained.

Further, in the lithium-excess-type lithium transition metal composite oxide, the oxygen position parameter determined from crystal structure analysis by a Rietveld method based on an X-ray diffraction pattern is preferably 0.262 or less at a discharge end of 2 V (vs. Li/Li⁺) and 0.267 or more at a discharge end of 4.3 V (vs. Li/Li⁺) after overcharge formation. Accordingly, a lithium secondary battery excellent in high rate discharge performance can be obtained. The oxygen position parameter refers to a value of z where the spatial coordinate of Me (transition metal) is defined as (0,0,0), the spatial coordinate of Li (lithium) is defined as (0,0,1/2), and the spatial coordinate of O (oxygen) is defined as (0,0,z) for the α-NaFeO₂-type crystal structure of the lithium transition metal composite oxide belonging to space group R3-m. That is, the oxygen position parameter serves as an indication showing the distance of the O (oxygen) position from the Me (transition metal) position (see Patent Documents 1 and 2).

The lithium-excess-type lithium transition metal composite oxide according to the embodiment is prepared from a carbonate precursor or a hydroxide precursor.

Lithium transition metal composite oxide particles prepared from a carbonate precursor have a D50 of preferably 5 μm or more, more preferably 5 to 18 μm where the D50 is a particle size corresponding to a cumulative volume of 50% in a particle size distribution of secondary particles. Lithium transition metal composite oxide particles prepared from a hydroxide precursor have a D50 of preferably 8 μm or less, more preferably 1 to 8 μm.

In the embodiment, for obtaining a positive active material for a lithium secondary battery, which is excellent in initial efficiency and cycle performance, it is preferable that the lithium-excess-type lithium transition metal composite oxide prepared from a carbonate precursor has a peak differential pore volume of 0.75 mm³/(g·nm) or more when the pore diameter at which the differential pore volume determined by a BJH method from an adsorption isotherm obtained using a nitrogen gas adsorption method reaches the maximum value is in the range of 30 to 40 nm (see Patent Document 2).

The tap density of the positive active material according to the embodiment is preferably 1.25 g/cc or more, more preferably 1.7 g/cc or more for obtaining a lithium secondary battery excellent in cycle performance and high rate discharge performance.

A method for producing the lithium-excess-type lithium transition metal composite oxide of the embodiment will now be described.

The lithium-excess-type lithium transition metal composite oxide of the embodiment can be obtained by preparing a raw material so as to contain metal elements (Li, Mn, Co and Ni), which form the lithium transition metal composite oxide, in accordance with a desired composition of the lithium transition metal composite oxide, and firing the prepared raw material. For the amount of the Li raw material, however, it is preferable to incorporate the Li raw material in an excessive amount by about 1 to 5% in consideration of disappearance of a part thereof during firing.

In preparation of an oxide having a desired composition, so called a “solid phase method” in which salts of Li, Co, Ni and Mn are mixed and fired, and a “coprecipitation method” in which a coprecipitation precursor with Co, Ni and Mn made to existing in one particle is prepared beforehand, and a Li salt is mixed thereto, and the mixture is fired are known. In the synthesis process of the “solid phase method”, particularly Mn is hard to be uniformly dissolved with Co and Ni. Therefore it is difficult to obtain a sample in which the elements are uniformly distributed in one particle. According to previous documents, many attempts have been made to dissolve with a part of Ni or Co (to prepare LiNi₁₋ₓMnₓO₂ etc.) by the solid phase method, but it is easier to obtain a uniform phase at an atomic level when the “coprecipitation method” is selected. Thus, the “coprecipitation method” is employed in an embodiment as described later.

In preparation of a coprecipitation precursor, Mn is most easily oxidized among Co, Ni and Mn, so that it is not easy to prepare a coprecipitation precursor in which Co, Ni and Mn are uniformly distributed in a divalent state, and therefore uniform mixing of Co, Ni and Mn at an atomic level is apt to be insufficient. Particularly in the composition range in the embodiment, the ratio of Mn is high as compared to the ratios of Co and Ni, and therefore it is particularly important to remove dissolved oxygen in an aqueous solution. Examples of the method for removing dissolved oxygen include a method including bubbling a gas that does not contain oxygen. The gas that does not contain oxygen is not limited, and a nitrogen gas, an argon gas, carbon dioxide (CO₂) or the like can be used. Particularly, in the case where a coprecipitation carbonate precursor is prepared, employment of carbon dioxide as a gas that does not contain oxygen is preferable because an environment is provided in which the carbonate is more easily generated.

The pH in the step of producing a precursor by coprecipitating in a solution a compound containing Co, Ni and Mn is not limited. The pH may be 10 to 14 when the coprecipitation precursor is to be prepared as a coprecipitation hydroxide precursor, and the pH may be 7.5 to 11 when the coprecipitation precursor is to be prepared as a coprecipitation carbonate precursor. It is preferable to control the pH for increasing the tap density. For the coprecipitation carbonate precursor, when the pH is 9.4 or less, it can be ensured that the tap density is 1.25 g/cc or more, so that high rate discharge performance can be improved. Further, when the pH is 8.0 or less, the particle growth rate can be accelerated, so that the stirring duration after completion of dropwise addition of a raw material aqueous solution can be reduced.

The coprecipitation precursor is preferably a compound in which Mn, Ni and Co are uniformly mixed. A precursor having a higher bulk density can also be prepared by using, for example, a crystallization reaction using a complexing agent. At this time, when the precursor is mixed with a Li source and the mixture is fired, an active material having a higher density can be obtained, and therefore the energy density per electrode area can be increased.

Examples of the raw material of the coprecipitation precursor may include manganese oxide, manganese carbonate, manganese sulfate, manganese nitrate and manganese acetate for the Mn compound, nickel hydroxide, nickel carbonate, nickel sulfate, nickel nitrate and nickel acetate for the Ni compound, and cobalt sulfate, cobalt nitrate and cobalt acetate for the Co compound.

In the embodiment, a reaction crystallization method is employed in which a raw material aqueous solution of the coprecipitation precursor is continuously added and supplied to a reaction tank that is kept alkaline. Here, a lithium compound, a sodium compound, a potassium compound or the like can be used as a neutralizing agent. It is preferable to use sodium hydroxide, a mixture of sodium hydroxide and lithium hydroxide, or a mixture of sodium hydroxide and potassium hydroxide in the case where the coprecipitation precursor is prepared as a coprecipitation hydroxide precursor. It is preferable to use sodium carbonate, a mixture of sodium carbonate and lithium carbonate, or a mixture of sodium carbonate and potassium carbonate in the case where the coprecipitation precursor is prepared as a coprecipitation carbonate precursor. For ensuring that 1000 ppm or more of Na remains, the molar ratio of sodium carbonate (sodium hydroxide) to lithium carbonate (lithium hydroxide) (Na/Li) or the molar ratio of sodium carbonate (sodium hydroxide) to potassium carbonate (potassium hydroxide) (Na/K) is preferably 1/1 [M] or more. When the Na/Li ratio or Na/K ratio is 1/1 [M] or more, the possibility can be reduced that Na is excessively removed in the subsequent washing step, resulting in the Na content of less than 1000 ppm.

The dropwise addition rate of the raw material aqueous solution significantly affects uniformity of the distribution of elements in one particle of a coprecipitation precursor to be generated. Particularly, Mn requires caution because it is hard to form a uniform element distribution with Co and Ni. The preferable dropwise addition rate depends on the size of a reaction tank, stirring conditions, pH, the reaction temperature and the like, but the dropwise addition rate is preferably 30 ml/min or less. For increasing the discharge capacity, the dropwise addition rate is more preferably 10 ml/min or less, most preferably 5 ml/min or less.

When a complexing agent exists in the reaction tank, and a certain convective condition is applied, rotation of particles and revolution of particles in the stirring tank are accelerated by further continuing stirring after completion of dropwise addition of the raw material aqueous solution. In this process, particles gradually grow into a concentric spherical shape while the particles collide with one another. That is, the coprecipitation precursor is formed through a two-step reaction including a metal complex formation reaction in dropwise addition of the raw material aqueous solution into the reaction tank and a precipitation formation reaction that takes place during retention of the metal complex. Therefore, a coprecipitation precursor having a desired particle size can be obtained by appropriately selecting a duration during which stirring is further continued after completion of stepwise addition of the raw material aqueous solution.

The preferable stirring duration after completion of dropwise addition of the raw material aqueous solution depends on the size of a reaction tank, stirring conditions, pH, the reaction temperature and the like. The stirring duration is preferably 0.5 h or more, more preferably 1 h or more for growing particles as uniform spherical particles. The stirring duration is preferably 30 h or less, more preferably 25 h or less, most preferably 20 h or less for reducing the possibility that the particle size excessively increases, so that power performance in a low SOC region of a battery is not sufficient.

The preferable stirring duration for ensuring that the 50% particle size (D50) of the lithium transition metal composite oxide prepared from the coprecipitation hydroxide precursor is 1 to 8 μm, and the preferable stirring duration for ensuring that the 50% particle size (D50) of the lithium transition metal composite oxide prepared from the coprecipitation carbonate precursor is 5 to 18 μm vary depending on the controlled pH. For example, for the coprecipitation hydroxide precursor, the stirring duration is preferably 1 to 10 h when the pH is controlled to 10 to 12, and the stirring duration is preferably 3 to 20 h when the pH is controlled to 12 to 14. For the coprecipitation carbonate precursor, the stirring duration is preferably 1 to 20 h when the pH is controlled to 7.5 to 8.2, and the stirring duration is preferably 3 to 24 h when the pH is controlled to 8.3 to 9.4.

When coprecipitation precursor particles are prepared using as a neutralizing agent a sodium compound such as sodium hydroxide or sodium carbonate, sodium ions deposited on the particles are washed off in the subsequent washing step. In the embodiment, it is preferable to wash off the sodium ions under a condition which ensures that 1000 ppm or more of Na remains. For example, a condition can be employed in which washing is performed five times with 200 ml of ion-exchange water at the time when the prepared coprecipitation precursor is suction-filtered and taken out.

Preferably, the coprecipitation precursor is dried at a temperature of 80° C. to lower than 100° C. under normal pressure in an air atmosphere. A larger amount of water can be removed in a short time by drying the coprecipitation precursor at 100° C. or higher, but an active material exhibiting more satisfactory electrode characteristics can be provided by drying the coprecipitation precursor at 80° C. over a long time. The reason for this is not exactly known, but the present inventors make the following assumption for the carbonate precursor. That is, the carbonate precursor is a porous material having a specific surface area of 50 to 100 m²/g, so that water is easily adsorbed to the carbonate precursor. Thus, when the coprecipitation precursor is dried at a low temperature to allow a measurable amount of water to remain in pores in the state of the precursor, molten Li can enter the pores so as to replace adsorbed water removed from the pores in a firing step of mixing the precursor with a Li salt and firing the mixture. Resultantly an active material having a more uniform composition may be obtained as compared to the case where the coprecipitation precursor is dried at 100° C. A carbonate precursor dried at 100° C. shows a blackish brown color while a carbonate precursor dried at 80° C. shows a flesh color, and therefore both the carbonate precursors can be discriminated from each other by the color of the precursor.

For quantitatively evaluating a difference between carbonate precursors, which is found as described above, the color phases of the precursors are measured, and compared with those in JPMA Standard Paint Colors, edition F, 2011, issued by Japan Paint Manufacturers Association, which conforms to JIS Z 8721. For measurement of the color phase, Color Reader CR10 manufactured by KONICA MINOLTA, INC. is used. In this measurement method, the value of dL* indicating a brightness is larger in white, and smaller in black.

The value of da* indicating a color phase increases as the red color becomes stronger, and decreases as the green color becomes stronger (the red color becomes weaker). The value of db* indicating a color phase increases as the yellow color becomes stronger, and increases as the blue color becomes stronger (the yellow color becomes weaker).

It has become apparent that the color phase of a product dried at 100° C. falls within a range to the standard color F05-40D in the red color direction with respect to the standard color F05-20B, and falls within a range to the standard color FN-25 in the white color direction with respect to the standard color FN-10. In particular, the color phase of this product has been found to have the smallest color difference between itself and the color phase of the standard color F05-20B.

On the other hand, it has become apparent that the color phase of a product dried at 80° C. falls within a range to the standard color F19-70F in the white color direction with respect to the standard color F19-50F, and falls within a range to the standard color F09-60H in the black color direction with respect to the standard color F09-80D. In particular, the color phase of this product has been found to have the smallest color difference between itself and the color phase of the standard color F19-50F.

From the above findings, it can be said that the color phase of the carbonate precursor is preferably positive in all the values of dL, da and db with respect to the standard color F05-20B, and more preferably has a dL value of +5 or more, a da value of +2 or more and a db value of +5 or more.

The lithium-excess-type lithium transition metal composite oxide of the embodiment can be suitably prepared by mixing the hydroxide precursor or carbonate precursor with a Li compound, and then heat-treating the mixture.

The Li compound can be suitably produced by using lithium hydroxide, lithium carbonate, lithium nitrate, lithium acetate or the like. For the amount of the Li compound, however, it is preferable to incorporate the Li compound in an excessive amount by about 1 to 5% in consideration of disappearance of a part thereof during firing.

In the embodiment, for ensuring that the content of Na in the lithium transition metal composite oxide is 1000 ppm or more, a Na compound is mixed with the hydroxide precursor or carbonate precursor along with the Li compound in the firing step, so that the amount of Na contained in the active material is 1000 ppm or more even through the amount of Na contained in the hydroxide precursor or carbonate precursor is 1000 ppm or less. The Na compound is preferably sodium carbonate.

The firing temperature affects the reversible capacity of the active material.

When the firing temperature is excessively high, the obtained active material is collapsed with an oxygen release reaction, and a phase of monoclinic crystals defined by the Li[Li_{1/3}Mn_{2/3}]O₂ type, in addition to hexagonal crystals, tends to be observed as a separate phase rather than a solid solution phase. Inclusion of such a split phase in an excessive amount is not preferable because the reversible capacity of the active material is reduced. In this material, an impurity peak is observed at around 35° or 45° on an X-ray diffraction pattern. Therefore, the firing temperature is preferably lower than a temperature at which the oxygen release reaction of the active material has influences. The oxygen release temperature of the active material is generally 1000° C. or higher in the composition range according to the embodiment, but since the oxygen release temperature slightly varies depending on a composition of the active material, it is preferable to confirm the oxygen release temperature of the active material beforehand. Since it has been confirmed that the oxygen release temperature is shifted toward a lower temperature side as the amount of Co contained in a sample increases, caution is required particularly when the amount of Co is high. As a method for confirming the oxygen release temperature of the active material, a mixture of a coprecipitation precursor and a lithium compound may be subjected to thermogravimetric analysis (DTA-TG measurement) for simulating a firing reaction process, but in this method, platinum used for a sample chamber of a measuring apparatus may be corroded with a volatilized Li component to damage the apparatus, and therefore a composition crystallized to some extent by employing a firing temperature of about 500° C. beforehand should be subjected to thermogravimetric analysis.

On the other hand, when the firing temperature is excessively low, electrode characteristics tend to be deteriorated because crystallization does not sufficiently proceed. In the embodiment, it is preferable that the firing temperature is 700° C. or higher when a coprecipitation hydroxide is used as the precursor. It is preferable that the firing temperature is 800° C. or higher when a coprecipitation carbonate is used as the precursor. Particularly, when the precursor is a coprecipitation carbonate, the optimum firing temperature tends to become lower as the amount of Co contained in the precursor increases. By sufficiently crystallizing crystallites that form primary particles as described above, the resistance at a crystal grain boundary can be reduced to promote smooth transportation of lithium ions.

By minutely analyzing a half-width of a diffraction peak of the active material according to the embodiment, the present inventors have confirmed that when the precursor is a coprecipitation hydroxide, strain remains in a lattice in a sample synthesized at a temperature of lower than 650° C., and strain can be eliminated by synthesis at a temperature of 650° C. or higher, and when the precursor is a coprecipitation carbonate, strain remains in a lattice in a sample synthesized at a temperature of lower than 750° C., and strain can be remarkably eliminated by synthesis at a temperature of 750° C. or higher. Further, the size of the crystallite increases in proportion as the synthesis temperature rises.

Accordingly, a good discharge capacity is also obtained by seeking particles having little lattice strain in the system and having a sufficiently grown crystallite size in the composition of the active material according to the embodiment.

Specifically, it has become apparent that employment of a synthesis temperature (firing temperature) and a Li/Me ratio composition at which the strain amount affecting a lattice constant is 2% or less and the crystallite size is grown to 50 nm or more is preferable. When the active material is formed as an electrode and charge-discharge is performed, a change by expansion and contraction is observed, but it is preferable in terms of an effect obtained that the crystallite size is kept to be 30 nm or more even in the charge-discharge process.

As described above, the firing temperature is related to the oxygen release temperature of the active material, but a crystallization phenomenon occurs at 900° C. or higher due to growth of primary particles to a large size even though a firing temperature at which oxygen is released from the active material is not reached. This can be confirmed by observing the active material after firing with a scanning electron microscope (SEM).

An active material synthesized through a synthesis temperature higher than 900° C. has primary particles grown to 0.5 μm or more, leading to a state disadvantageous to movement of Li in the active material during charge-discharge reaction, so that high rate discharge performance is deteriorated. The size of the primary particle is preferably less than 0.5 μm, more preferably 0.3 μm or less.

Accordingly, in the lithium-excess-type lithium transition metal composite oxide of the embodiment, the firing temperature is preferably 750 to 900° C., more preferably 800 to 900° C. when the Li/Me molar ratio (1+α)/(1−α) is more than 1.2 and less than 1.6.

For ensuring that the positive active material according to the embodiment has a high discharge capacity, the ratio at which transition metal elements that form a lithium-excess-type lithium transition metal composite oxide exist at portions other than transition metal sites of layered rock salt-type crystal structure is preferably low. This can be achieved by uniform distribution of transition metal elements of precursor core particles, such as Co, Ni and Mn, in a precursor to be subjected to a firing step and selection of appropriate conditions for the firing step for promoting crystallization of an active material sample. When the distribution of transition metals in the precursor core particles to be subjected to the firing step is not uniform, a sufficient discharge capacity is not obtained. The reason for this is not exactly known, but the present inventors make the assumption that when the distribution of transition metal elements in the precursor core particles to be subjected to the firing step is not uniform, the obtained lithium transition metal composite oxide falls into so called cation mixing where some of transition metal elements exist at portions other than transition metal sites of layered rock salt-type crystal structure, i.e. lithium sites. Similar assumption can also be applied in the crystallization process in the firing step, and when crystallization of an active material sample is insufficient, cation mixing in the layered rock salt-type crystal structure easily occurs. When uniformity of the distribution of the transition metal elements is high, the intensity ratio of diffraction peaks of the (003) plane and the (104) plane tends to be high when X-ray diffraction measurement results belong to the space group R3-m.

In the embodiment, the intensity ratio of diffraction peaks of the (003) plane and the (104) (I₍₀₀₃₎)/I₍₁₀₄₎) plane in X-ray diffraction measurement is preferably 1.0 or more at a discharge end and 1.75 or more at a charge end. When synthesis conditions and a synthesis procedure for the precursor are inappropriate, the peak intensity ratio is a smaller value, often a value smaller than 1.

The lithium-excess-type lithium transition metal composite oxide of the embodiment has been described above.

Next, for the LiMeO₂-type lithium transition metal composite oxide of the embodiment, one that is well known can be used. This lithium transition metal composite oxide is typically represented by the composition formula LiMeO₂ (where Me represents a transition metal element including Co, Ni and Mn, x≦1.2, and 0<Mn/Me molar ratio≦0.5). One example thereof is LiCo_{1/3}N_{1/3}Mn_{1/3}O₂, and it can be produced by, for example, a method in which a mixed solution of salts of Co, Ni and Mn is added dropwise in an alkali solution to prepare a coprecipitation hydroxide, the coprecipitation hydroxide is mixed with a Li salt, and the mixture is fired. A LiMeO₂-type lithium transition metal composite oxide in which the ratio of Co, Ni and Mn is changed, such as LiCo_{2/3}Ni_{1/6}Mn_{1/6}O₂ or LiCo_{0.3}Ni_{0.5}Mn_{0.2}O₂, can also be used.

LiMeO₂-type lithium transition metal composite oxide is acid-treated. It is preferable to use sulfuric acid for the acid treatment. Hydrochloric acid and nitric acid are not preferable because they dissolve the active material at a high speed. The LiMeO₂-type lithium transition metal composite oxide is acid-treated with sulfuric acid to incorporate S in the lithium transition metal composite oxide. The LiMeO₂-type lithium transition metal composite oxide is added to an aqueous sulfuric acid solution, and the mixture is stirred, then filtered, washed and dried to incorporate S in the lithium transition metal composite oxide. The content of S can be changed by controlling the sulfuric acid concentration.

The lithium-excess-type lithium transition metal composite oxide prepared in the manner described above is mixed with the acid-treated LiMeO₂-type lithium transition metal composite oxide to provide a mixed active material. In the embodiment, the content of S in the mixed active material is 0.2 to 1.0% by mass. The LiMeO₂-type lithium transition metal composite oxide does not undergo a significant increase in specific surface area when acid-treated, and therefore it can be ensured that the specific surface area of the mixed active material is 4.2 m²/g or less.

The negative electrode material is not limited, and any material capable of depositing or storing lithium ions may be selected. Examples include titanium-based materials such as lithium titanate having a spinel type crustal structure represented by Li[Li_{1/3}Ti_{5/3}]O₄, alloy-based material lithium metals such as Si-, Sb- and Sn-based materials, lithium alloys (lithium alloy-containing alloys such as lithium-silicon, lithium-aluminum, lithium-lead, lithium-tin, lithium-aluminum-tin, lithium-gallium and wood's alloys), lithium composite oxides (lithium-titanium), and silicon oxide as well as alloys capable of storing/releasing lithium and carbon materials (e.g. graphite, hard carbon, low-temperature baked carbon, amorphous carbon etc.).

The powder of the positive active material and the powder of the negative electrode material are desired to have an average particle size of 100 μm or less. Particularly, the powder of the positive active material is desired to have an average particle size of 10 μm or less for improving high power characteristics of the nonaqueous electrolyte battery. For obtaining a powder in a predetermined shape, a grinder or a classifier is used. For example, a mortar, a ball mill, a sand mill, a vibratory ball mill, a planetary ball mill, a jet mill, a counter jet mill, a whirling airflow type jet mill, a sieve or the like is used. Wet grinding in which water or an organic solvent such as hexane is made to coexist may also be used during grinding. The classification method is not particularly limited, and a sieve, a wind power classifier or the like is used as necessary in either a dry process or a wet process.

The positive active material and the negative electrode material, which are principal components of the positive electrode and the negative electrode, have been described in detail above, but the positive electrode and negative electrode may contain, in addition to the main components, a conducting agent, a binder, a thickener, a filler and the like as other components.

The conducting agent is not limited as long as it is an electron-conductive material which does not have a negative influence on battery performance, and usually natural graphite (scaly graphite, flaky graphite, earthy graphite etc.), artificial graphite, carbon black, acetylene black, ketjen black, carbon whiskers, carbon fibers, metal (copper, nickel, aluminum, silver, gold etc.) powders, metal fibers, conductive ceramic materials can be included alone or as a mixture thereof.

Among them, acetylene black is desirable as the conducting agent from the viewpoint of electron conductivity and coatability. The added amount of the conducting agent is preferably 0.1% by weight to 50% by weight, particularly preferably 0.5% by weight to 30% by weight based on the total weight of the positive electrode or the negative electrode. It is desirable to use acetylene black ground to ultrafine particles of 0.1 to 0.5 μm because the required amount of carbon can be reduced. The method for mixing thereof is based on physical mixing, and uniform mixing is ideal.

Therefore, mixing can be performed in a dry process or a wet process with a powder mixer such as a V-shape mixer, a S-shape mixer, a grinding machine, a ball mill or a planetary ball mill.

As the binder, usually, thermoplastic resins such as polytetrafluoroethylene (PTFE), polyvinylidene fluoride (PVDF), polyethylene and polypropylene, and polymers having rubber elasticity, such as ethylene-propylene-diene terpolymers (EPDM), sulfonated EPDM, styrene butadiene rubber (SBR) and fluororubber can be used alone or as a mixture of two or more thereof. The added amount of the binder is preferably 1 to 50% by weight, particularly preferably 2 to 30% by weight based on the total weight of the positive electrode or the negative electrode.

The filler may be any material as long as it does not have a negative influence on battery performance. Normally, an olefin-based polymer such as polypropylene or polyethylene, amorphous silica, alumina, zeolite, glass, carbon or the like is used. The added amount of the filler is preferably 30% by weight or less based on the total weight of the positive electrode or the negative electrode.

The positive electrode and the negative electrode are suitably prepared in the following manner: the main components (positive active material in positive electrode and negative electrode material in negative electrode) and other materials are mixed to form a composite, the composite is mixed with an organic solvent such as N-methylpyrrolidone or toluene or water, and the resulting mixed liquid is then applied or press-bonded onto a current collector such as an aluminum foil or a copper foil, and subjected to a heating treatment at a temperature of about 50° C. to 250° C. for about 2 hours. For the application method, it is desirable to apply the liquid in any thickness and any shape using means such as, for example, roller coating with an applicator roll or the like, screen coating, a doctor blade process, spin coating or a bar coater, but the application method is not limited thereto.

The nonaqueous electrolyte to be used for the lithium secondary battery according to the embodiment is not limited, and those that are generally proposed to be used for lithium batteries etc. can be used. Examples of the nonaqueous solvent to be used for the nonaqueous electrolyte may include, but are not limited to, the following compounds alone or mixtures of two or more thereof cyclic carbonates such as propylene carbonate, ethylene carbonate, butylene carbonate, chloroethylene carbonate and vinylene carbonate; cyclic esters such as γ-butyrolactone and γ-valerolactone; chain carbonates such as dimethyl carbonate, diethyl carbonate and ethyl methyl carbonate; chain esters such as methyl formate, methyl acetate and methyl lactate; tetrahydrofuran or derivatives thereof ethers such as 1,3-dioxane, 1,4-dioxane, 1,2-dimethoxyethane, 1,4-dibutoxyethane and methyl diglyme; nitriles such as acetonitrile and benzonitrile; dioxolane or derivatives thereof ethylene sulfide, sulfolane, sultone or derivatives thereof.

Examples of the electrolyte salt to be used for the nonaqueous electrolyte include inorganic ion salts including one of lithium (Li), sodium (Na) and potassium (K), such as LiClO₄, LiBF₄, LiAsF₆, LiPF₆, LiSCN, LiBr, LiI, Li₂SO₄, Li₂B₁₀Cl₁₀, NaClO₄, NaI, NaSCN, NaBr, KClO₄ and KSCN; and organic ion salts such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearylsulfonate, lithium octylsulfonate and lithium dodecylbenzenesulfonate, and these ionic compounds can be used alone or as a mixture of two or more thereof.

Further, it is more desirable to use a mixture of LiPF₆ or LiBF₄ and a lithium salt having perfluoroalkyl group, such as LiN(C₂F₅SO₂)₂ because the viscosity of the electrolyte can be further reduced, so that low temperature characteristics can be further enhanced, and self discharge can be suppressed.

An ordinary temperature molten salt or an ion liquid may be used as the nonaqueous electrolyte.

The concentration of the electrolyte salt in the nonaqueous electrolyte is preferably 0.1 mol/1 to 5 mol/l, further preferably 0.5 mol/l to 2.5 mol/l for reliably obtaining a nonaqueous electrolyte battery having high battery characteristics.

As a separator, it is preferable that porous membranes and nonwoven fabrics exhibiting excellent high rate discharge performance are used alone or in combination. Examples of the material that forms the separator for a nonaqueous electrolyte battery may include polyolefin-based resins represented by polyethylene, polypropylene and the like, polyester-based resins represented by polyethylene terephthalate, polybutylene terephthalate and the like, polyvinylidene fluoride, vinylidene fluoride-hexafluoropropylene copolymers, vinylidene fluoride-perfluorovinyl ether copolymers, vinylidene fluoride-tetrafluoroethylene copolymers, vinylidene fluoride-trifluoroethylene copolymers, vinylidene fluoride-fluoroethylene copolymers, vinylidene fluoride-hexafluoroacetone copolymers, vinylidene fluoride-ethylene copolymers, vinylidene fluoride-propylene copolymers, vinylidene fluoride-trifluoropropylene copolymers, vinylidene fluoride-tetrafluoroethylene-hexafluoropropylene copolymers and vinylidene fluoride-ethylene-tetrafluoroethylene copolymers.

The porosity of the separator is preferably 98% by volume or less from the viewpoint of strength. The porosity is preferably 20% by volume or more from the viewpoint of charge-discharge characteristics.

For the separator, a polymer gel including a polymer such as acrylonitrile, ethylene oxide, propylene oxide, methyl methacrylate, vinyl acetate, vinylpyrrolidone or polyvinylidene fluoride and an electrolyte may be used. It is preferable to use the nonaqueous electrolyte in a gel state as described above because an effect of preventing liquid leakage is provided.

It is desirable to use as a separator the above-mentioned porous membrane, nonwoven fabric or the like in combination with a polymer gel because liquid retainability of the electrolyte is improved. That is, a film with the surface and the microporous wall face of a polyethylene microporous membrane coated with a solvent-philic polymer having a thickness of several μm or less is formed, and an electrolyte is held in micropores of the film, so that the solvent-philic polymer gelates.

Examples of the solvent-philic polymer include, in addition to polyvinylidene fluoride, polymers in which an acrylate monomer and an epoxy monomer having an ethylene oxide group, an ester group etc., a monomer having an isocyanate group, and the like are crosslinked. The monomer can be made to undergo a crosslinking reaction using heating or ultraviolet rays (UV) in combination with a radical initiator or using active beams such as electron beams (EB).

The configuration of the lithium secondary battery of the embodiment is not particularly limited, and examples include cylindrical batteries having a positive electrode, a negative electrode and a roll-shaped separator, prismatic batteries and flat batteries. When the lithium secondary battery of the embodiment is used as a power source for a car such as an electric car (EV), a hybrid car (HEV) or a plugin hybrid car (PHEV), the lithium secondary battery can be mounted in the form of a battery module (assembled battery) having a plurality of lithium secondary batteries.

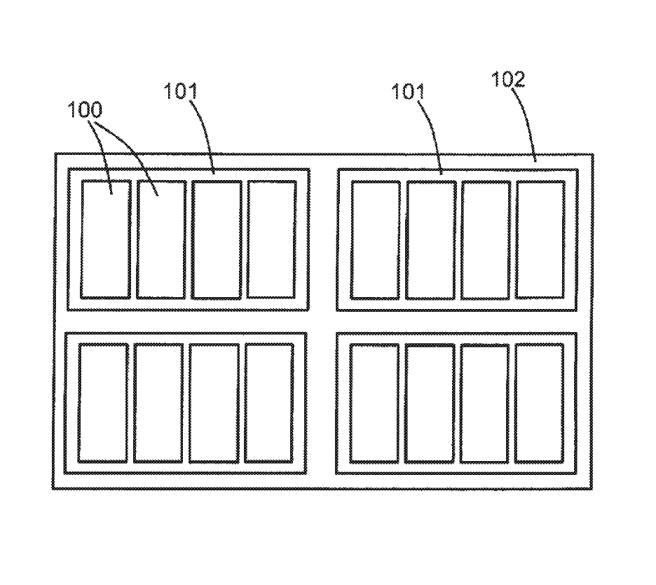

The lithium secondary battery of the embodiment may form a power storage apparatus such as an assembled battery or a battery pack. As shown in FIG. 1, an assembled battery 101 is configured by assembling a plurality of lithium secondary batteries 100. A battery pack 102 may include a plurality of assembled batteries 101.

Both conventional positive active materials and the active material of the embodiment can be charged/discharged at a positive electrode potential of around 4.5 V (vs. Li/Li⁺). However, depending on a type of nonaqueous electrolyte to be used, the nonaqueous electrolyte may be oxidized and decomposed to cause deterioration of battery performance when the positive electrode potential during charging is excessively high. Therefore, a lithium secondary battery may be required which has a sufficient discharge capacity even when such a charge method that the maximum ultimate potential of a positive electrode during charging is 4.3 V (vs. Li/Li⁺) or less is employed at the time of use of the battery. When the active material of the embodiment is used, a discharge capacity higher than the capacity of the conventional positive active material, i.e. about 200 mAh/g or more, can be achieved even when such a charge method that the maximum ultimate potential of a positive electrode during charging is less than 4.5 V (vs. Li/Li⁺), for example 4.4 V (vs. Li/Li⁺) or less or 4.3 V (vs. Li/Li⁺) or less, is employed at the time of use of the battery.

By employing the synthesis conditions and synthesis procedures described in this specification, a high-performance positive active material as described above can be obtained.

### EXAMPLES

### Example 1

### Preparation of Lithium-Excess-Type Lithium Transition Metal Composite Oxide

Cobalt sulfate heptahydrate (14.08 g), 21.00 g of nickel sulfate hexahydrate and 65.27 g of manganese sulfate pentahydrate were weighed, and totally dissolved in 200 ml of ion-exchange water to prepare a 2.0 M aqueous sulfate solution in which the molar ratio of Co:Ni:Mn was 12.5:20.0:67.5. On the other hand, 750 ml of ion-exchange water was poured in a 2 L reaction tank, and a CO₂ gas was bubbled for 30 min to dissolve the CO₂ gas in the ion-exchange water. The temperature of the reaction tank was set to 50° C. (±2° C.), the aqueous sulfate solution was added dropwise at a rate of 3 ml/min while the contents of the reaction tank were stirred at a rotation speed of 700 rpm using paddle impeller equipped with a stirring motor. Here, control was performed so that pH in the reaction tank was kept at 7.9 (±0.05) by appropriately adding dropwise an aqueous solution containing 2.0 M sodium carbonate and 0.4 M ammonia over a time period between the start and the end of dropwise addition. After completion of dropwise addition, stirring the contents in the reaction tank was continued for further 3 hours. After stirring was stopped, the reaction tank was left standing for 12 hours or more.

Next, particles of a coprecipitation carbonate generated in the reaction tank were separated using a suction filtration device. Further, sodium ions deposited on the particles were washed off in a condition in which washing is performed five times, each time washed with 200 ml of ion-exchange water. Then, the particles were dried at 80° C. for 20 h under normal pressure in an air atmosphere using an electric furnace. Thereafter, the particles were ground with an agate automatic mortar for several minutes to equalize the particle size. In this way, a coprecipitation carbonate precursor was prepared.

Lithium carbonate (1.022 g) was added to 2.228 g of the precipitation carbonate precursor, and the mixture was sufficiently mixed with an agate automatic mortar to prepare a mixed powder in which the molar ratio of Li:(Co, Ni, Mn) was 140:100. Using a pellet molding machine, the mixed powder was molded at a pressure of 6 MPa to provide pellets having a diameter of 25 mm. The amount of the mixed powder subjected to pellet molding was determined by performing calculation in such a manner that the estimated mass of a final product was 2 g. One of the pellets was placed on an alumina boat having a total length of about 100 mm, and the alumina boat was placed in a box-shaped electric furnace (Model: AMF20), heated to 900° C. from normal temperature under normal pressure over 10 hours, and pre-fired at 900° C. for 4 h. The box-type electric furnace has an internal dimension of 10 cm (height), 20 cm (width) and 30 cm (depth), and is provided with electrically heated wires at intervals of 20 cm in the width direction. After firing, a heater was switched off, and the alumina boat was naturally cooled as it was left standing in the furnace. As a result, the temperature of the furnace decreased to about 200° C. after 5 hours, and thereafter the temperature slightly gently decreased. After elapse of a whole day and night, the pellet was taken out after confirming that the temperature of the furnace was 100° C. or lower, and the pellet was ground with an agate automatic mortar for several minutes for equalizing the particle size. In this way, a lithium transition metal composite oxide (Li_{1.167}Co_{0.104}Ni_{0.167}Mn_{0.562}O₂) containing 2100 ppm of Na according to Example 1 was prepared.

The lithium transition metal composite oxide was confirmed to have an α-NaFeO₂ structure by X-ray diffraction measurement.

### [Acid Treatment of LiMeO₂-Type Lithium Transition Metal Composite Oxide]

LiCo_{0.33}Ni_{0.33} Mn_{0.33}O₂ (5 g) was weighed, and added to 100 mL of a 0.5 M aqueous sulfuric acid solution, and the mixture was stirred at room temperature for 30 min using a magnetic stirrer. Thereafter, the mixture was filtered and washed with ion-exchange water, and dried at normal pressure at 110° C. for 20 hours.

The lithium-excess-type lithium transition metal composite oxide prepared in the manner described above is mixed with the acid-treated LiMeO₂-type lithium transition metal composite oxide at a mass ratio of 9:1 to provide a mixed active material of Example 1.

### Example 2

A mixed active material of Example 2 was prepared in the same manner as in Example 1 except that the concentration of the aqueous sulfuric acid solution to which LiCo_{0.33}Ni_{0.33} Mn_{0.33}O₂ was added in the step of acid-treating the LiMeO₂-type lithium transition metal composite oxide was changed from 0.5 M to 1.0 M.

### Example 3

A mixed active material of Example 3 was prepared in the same manner as in Example 1 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 0.5 M to 1.5 M.

### Example 4

A mixed active material of Example 4 was prepared in the same manner as in Example 1 except that in the step of preparing a lithium-excess-type lithium transition metal composite oxide, 0.943 g of lithium carbonate was added to 2.304 g of the coprecipitation carbonate precursor to prepare a mixed powder in which the molar ratio of Li:(Co, Ni, Mn) was 125:100, so that a lithium transition metal composite oxide (Li_{1.111}Co_{0.111}Ni_{0.178}Mn_{0.600}O₂) was prepared.

### Example 5

A mixed active material of Example 5 was prepared in the same manner as in Example 1 except that in the step of preparing a lithium-excess-type lithium transition metal composite oxide, 1.071 g of lithium carbonate was added to 2.180 g of the coprecipitation carbonate precursor to prepare a mixed powder in which the molar ratio of Li:(Co, Ni, Mn) was 150:100, so that a lithium transition metal composite oxide (Li_{1.20}Co_{0.10}Ni_{0.16}Mn_{0.54}O₂) was prepared.

### Example 6

A mixed active material of Example 6 was prepared in the same manner as in Example 1 except that in the step of preparing a lithium-excess-type lithium transition metal composite oxide, 1.107 g of lithium carbonate was added to 2.145 g of the coprecipitation carbonate precursor to prepare a mixed powder in which the molar ratio of Li:(Co, Ni, Mn) was 157.5:100, so that a lithium transition metal composite oxide (Li_{1.223} Co_{0.087}Ni_{0.155} Mn_{0.525}O₂) was prepared, and the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 0.5 M to 1.75 M.

### Example 7

A mixed active material of Example 7 was prepared in the same manner as in Example 6 except that in the step of preparing a lithium-excess-type lithium transition metal composite oxide, 1.095 g of lithium carbonate was added to 2.157 g of the coprecipitation carbonate precursor to prepare a mixed powder in which the molar ratio of Li:(Co, Ni, Mn) was 155:100, so that a lithium transition metal composite oxide (Li_{1.216}Co_{0.098}Ni_{0.157} Mn_{0.529}O₂) was prepared.

### Example 8

A mixed active material of Example 8 was prepared in the same manner as in Example 6 except that in the step of preparing a lithium-excess-type lithium transition metal composite oxide, 1.083 g of lithium carbonate was added to 2.168 g of the coprecipitation carbonate precursor to prepare a mixed powder in which the molar ratio of Li:(Co, Ni, Mn) was 152.5:100, so that a lithium transition metal composite oxide (Li_{1.208}Co_{0.099}Ni_{0.158} Mn_{0.535}O₂) was prepared.

### Example 9

A mixed active material of Example 9 was prepared in the same manner as in Example 6 except that in the step of preparing a lithium-excess-type lithium transition metal composite oxide, 1.071 g of lithium carbonate was added to 2.180 g of the coprecipitation carbonate precursor to prepare a mixed powder in which the molar ratio of Li:(Co, Ni, Mn) was 150:100, so that a lithium transition metal composite oxide (Li_{1.20}Co_{0.10}Ni_{0.16}Mn_{0.54}O₂) was prepared.

### Example 10

A mixed active material of Example 10 was prepared in the same manner as in Example 6 except that in the step of preparing a lithium-excess-type lithium transition metal composite oxide, 1.059 g of lithium carbonate was added to 2.192 g of the coprecipitation carbonate precursor to prepare a mixed powder in which the molar ratio of Li:(Co, Ni, Mn) was 147.5:100, so that a lithium transition metal composite oxide (Li_{1.192}Co_{0.101}Ni_{0.162}Mn_{0.545}O₂) was prepared.

### Comparative Example 1

A mixed active material of Comparative Example 1 was prepared in the same manner as in Example 6 except that in the step of preparing a lithium-excess-type lithium transition metal composite oxide, 1.047 g of lithium carbonate was added to 2.204 g of the coprecipitation carbonate precursor to prepare a mixed powder in which the molar ratio of Li:(Co, Ni, Mn) was 145:100, so that a lithium transition metal composite oxide (Li_{1.184}Co_{0.102}Ni_{0.163} Mn_{0.551}O₂) was prepared.

### Comparative Example 2

A mixed active material of Comparative Example 2 was prepared in the same manner as in Example 6 except that in the step of preparing a lithium-excess-type lithium transition metal composite oxide, 1.034 g of lithium carbonate was added to 2.216 g of the coprecipitation carbonate precursor to prepare a mixed powder in which the molar ratio of Li:(Co, Ni, Mn) was 142.5:100, so that a lithium transition metal composite oxide (Li_{1.175}Co_{0.103}Ni_{0.165}Mn_{0.557}O₂) was prepared.

### Comparative Example 3

A mixed active material of Comparative Example 3 was prepared in the same manner as in Example 1 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 0.5 M to 1.75 M.

### Comparative Example 4

A mixed active material of Comparative Example 4 was prepared in the same manner as in Example 7 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 5

A mixed active material of Comparative Example 5 was prepared in the same manner as in Example 8 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 6

A mixed active material of Comparative Example 6 was prepared in the same manner as in Example 9 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 7

A mixed active material of Comparative Example 7 was prepared in the same manner as in Example 10 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 8

A mixed active material of Comparative Example 8 was prepared in the same manner as in Comparative Example 1 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 9

A mixed active material of Comparative Example 9 was prepared in the same manner as in Comparative Example 2 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 10

A mixed active material of Comparative Example 10 was prepared in the same manner as in Comparative Example 3 except that the concentration of the aqueous sulfuric acid solution to which LiCo_{0.33}Ni_{0.33}Mn_{0.33}O₂ was added in the step of acid-treating a LiMeO₂-type lithium transition metal composite oxide was changed from 1.75 M to 2 M.

### Comparative Example 11

A mixed active material of Comparative Example 11 was prepared in the same manner as in Example 1 except that LiCo_{0.33}Ni_{0.33}Mn_{0.33}O₂ was not acid-treated in the step of acid-treating a LiMeO₂-type lithium transition metal composite oxide.

### Comparative Example 12

A lithium transition metal composite oxide (Li_{1.17}Co_{0.10}Ni_{0.17}Mn_{0.56}O₂) (5 g) prepared in the step of preparing a lithium-excess-type transition metal composite oxide was weighed, and added to 100 mL of a 1.75 M aqueous sulfuric acid solution, and the mixture was stirred at room temperature for 30 min using a magnetic stirrer. Thereafter, the mixture was filtered and washed with ion-exchange water, and dried at normal pressure at 110° C. for 20 hours. A mixed active material of Comparative Example 12 was prepared in the same manner as in Example 1 except that the acid-treated Li_{1.17}Co_{0.10}Ni_{0.17}Mn_{0.56}O₂ was mixed with LiCo_{0.33}Ni_{0.33}:Mn_{0.33}O₂ which was not acid-treated.

### Comparative Example 13

A mixed active material of Comparative Example 13 was prepared in the same manner as in Example 1 except that acid-treated Li_{1.17}Co_{0.10}Ni_{0.17}Mn_{0.56}O₂ in Comparative Example 12 was used in place of Li_{1.17}Co_{0.10}Ni_{0.17}Mn_{0.56}O₂ which was not acid-treated.

### Comparative Example 14

An active material of Comparative Example 14 was prepared in the same manner as in Example 1 except that Li_{0.33}Co_{0.33}Ni_{0.163} Mn_{0.33}O₂ was not mixed.

### Comparative Example 15

An active material of Comparative Example 15 was prepared in the same manner as in Comparative Example 12 except that LiCo_{0.33}Ni_{0.33}Mn_{0.33}O₂ was not mixed.

### Comparative Example 16

A mixed active material of Comparative Example 16 was prepared in the same manner as in Example 1 except that LiCo_{0.33}Ni_{0.33}Mn_{0.33}O₂ was treated with hydrochloric acid (using 100 mL of a 1 M aqueous hydrochloric acid solution in place of 100 mL of a 0.5 M aqueous sulfuric acid solution) in the step of acid-treating a LiMeO₂-type lithium transition metal composite oxide.

### Comparative Example 17

A mixed active material of Comparative Example 17 was prepared in the same manner as in Example 1 except that LiCo_{0.33}Ni_{0.33}Mn_{0.33}O₂ was treated with nitric acid (using 100 mL of a 1 M aqueous nitric acid solution in place of 100 mL of a 0.5 M aqueous sulfuric acid solution) in the step of acid-treating a LiMeO₂-type lithium transition metal composite oxide.

### Comparative Example 18

An active material of Comparative Example 18 was prepared in the same manner as in Comparative Example 11 except that Li_{1.17}Co_{0.10}Ni_{0.17}Mn_{0.56}O₂ was not mixed.

### Comparative Example 19

An active material of Comparative Example 19 was prepared in the same manner as in Example 1 except that Li_{1.17}Co_{0.10}Ni_{0.17}Mn_{0.56}O₂ was not mixed.

### <Preparation and Evaluation of Lithium Secondary Battery>

Using the active material of each of Examples 1 to 10 and Comparative Examples 1 to 19, a lithium secondary battery (model cell) was prepared in accordance with the following procedure and battery characteristics were evaluated.

An active material, acetylene black (AB) and a 12 mass % NMP solution of PVdF (Polyvinylidene Fluoride, #1100, KUREHA) were mixed in such a manner that the ratio of active material: AB:PVdF was 90:5:5, NMP (N-methyl-2-pyrolidon) was added in such a manner that the solid concentration was 43 mass %, and the mixture was mixed to obtain a paste. The thus-obtained paste was manually applied onto a 20 μm-thick aluminum foil using an applicator manufactured by YOSHIMITSU SEIKI K.K. Further, the paste was dried on a hot plate at 120° C. to remove a NMP solvent. Subsequently, an electrode was cut out to a size of 5.0 cm×3.0 cm, and caused to pass through a roll press machine several times, thereby obtaining an electrode adjusted to have a porosity of 35%. Finally, the electrode was vacuum-dried at 120° C. for 6 hours, so that water is completely removed to obtain a positive electrode.

For a negative electrode, a composite was applied onto a copper foil in such a manner that the weight ratio of graphite/PVdF was 94:6. Otherwise the same procedure as in the case of the positive electrode was carried out.

In both the positive and negative electrodes, the application weight was adjusted so that the weight of the active material was 60 mg.

Preparation of a model cell using the positive and negative electrodes prepared as described above was performed in accordance with the following procedure. All the operations for preparation of the model cell were carried out in a dry room for avoiding ingress of water. First, the active material on the lead attachment portions of the positive and negative electrodes having a predetermined size (5.0 cm×3.0 cm) was removed, and the electrodes were cut in an L shape. Subsequently, the mass of each of the resulting plates was measured, an aluminum lead and a nickel lead were then ultrasonically welded to the positive electrode and the negative electrode, respectively, and the electrodes were inserted into a single-layered PE separator bag (H6022, Asahi Kasei Corporation, 25 μm) with the positive electrodes facing each other. Further, this was put in a laminated bag, the bag was heat-sealed on one side (240° C.×15 seconds), 0.5 ml of an electrolyte solution was added, and the bag was then heat-sealed (240° C.×5 seconds) to be closed. As the electrolyte solution, a solution prepared in the following manner was used: a LiPF₆ salt was dissolved in a mixed solvent of EC:DMC:MEC=6:7:7 (volume ratio) in such a manner that the concentration of the salt was 1 mol dm⁻³.

Next, a charge-discharge test was conducted using the prepared model cell. The details of the test are as follows.

In the initial activation process, the cell was swept at a constant current of 0.1 C until the voltage reached 4.5 V, and the cell was then charged until the current value decreased to 0.02 C. Thereafter, the cell was halted for 10 minutes, then discharged to 2.0 V at a constant current of 0.1 C, and then halted for 10 minutes. This charge-discharge cycle was performed twice. Subsequently, the charge-discharge cycle was performed with the charge voltage changed to 4.2 V, and the discharge capacity obtained at this time was defined as a battery capacity. Thirty cycles of the charge discharge were performed with the current value changed to 1 C rate, followed by changing the current value to 0.1 C. The retention ratio of the energy density at this time was defined as a cycle energy density retention ratio.

### <Measurement of Specific Surface Area and Analysis of Content of S>

For measurement of the specific surface area of the active material and analysis of the content of S in the active material, the active material in the electrode in the test battery was collected. The positive electrode plate was taken out from the battery disassembled in a discharged state, and the electrolyte solution deposited on the electrode was sufficiently washed off with DMC. Thereafter, the composite on the Al current collector (aluminum foil) was collected, and fired at 600° C. for 4 hours using the small electric furnace, so that carbon as a conducting agent and the PVdF binder as a binder were removed to obtain only a mixed active material.

Measurement of the specific surface area was performed by a BET one-point method, and a numerical value obtained by dividing the measured value by the mass of the mixed active material was determined as the specific surface area.

The content of S was calculated by ICP measurement. The active material (50 mg) was dissolved in 10 ml of a 35% aqueous hydrochloric acid solution to provide a sample for measurement. A calibration curve was prepared using a standard solution separately, and the content was determined by making a comparison with the calibration curve.

### <Press Processability Test>

The positive electrode plate obtained by disassembling the battery in the manner described above was washed with DMC, then sufficiently dried, and then subjected to flat-pressing at 20 kN (hydraulic pump TYPE P-1B manufactured by RIKENKIKI CO., LTD, press stand CDM-20M), and detachment of the composite from the Al current collector was checked. The result showed that the composite was not detached from the current collector.

The results of measuring the specific surface area of the mixed active material and the results of analyzing the content of S for the active materials of Examples 1 to 10 and Comparative Examples 1 to 19, and the results of testing the lithium secondary batteries using the active materials for the initial efficiency, battery capacity and cycle energy density retention ratio are shown in Tables 1 and 2.

TABLE 1

| | | | | | Specific | | | | |
|---|---|---|---|---|---|---|---|---|---|
| | | | | | surface | | | | |
| | | | | | area of | | | | Cycle |
| | Lithium-excess-type lithium transition | | LiMeO₂-type lithium transition | | mixed | | | | energy |
| | metal composite oxide | | metal composite oxide | | active | Content | Initial | Battery | density |
| | | Acid | | Acid | material | of S | efficiency | capacity | retention |
| | Composition | treatment | Composition | treatment | [m²/g] | [%] | [%] | [mAh] | ratio [%] |
| Example 1 | Li_{1.167}Co_{0.104}Ni_{0.167}Mn_{0.662}O₂ | Not done | LiCo_{0.33}Ni_{0.33}Mn_{0.33}O₂ | Done | 3.8 | 0.2 | 94 | 25 | 91 |
| Example 2 | Li_{1.167}Co_{0.104}Ni_{0.167}Mn_{0.662}O₂ | Not done | LiCo_{0.33}Ni_{0.33}Mn_{0.33}O₂ | Done | 4.0 | 0.5 | 95 | 26 | 90 |
| Example 3 | Li_{1.167}Co_{0.104}Ni_{0.167}Mn_{0.662}O₂ | Not done | LiCo_{0.33}Ni_{0.33}Mn_{0.33}O₂ | Done | 4.2 | 1 | 95 | 26 | 90 |
| Example 4 | Li_{1.111}Co_{0.111}Ni_{0.178}Mn_{0.600}O₂ | Not done | LiCo_{0.33}Ni_{0.33}Mn_{0.33}O₂ | Done | 4.0 | 0.2 | 94 | 24 | 90 |
| Example 5 | Li_{1.20}Co_{0.10}Ni_{0.16}Mn_{0.54}O₂ | Not done | LiCo_{0.33}Ni_{0.33}Mn_{0.33}O₂ | Done | 3.5 | 0.2 | 94 | 24 | 90 |
| Example 6 | Li_{1.223}Co_{0.097}Ni_{0.155}Mn_{0.525}O₂ | Not done | LiCo_{0.33}Ni_{0.33}Mn_{0.33}O₂ | Done | 3.6 | 1.2 | 90 | 24 | 91 |
| Example 7 | Li_{1.216}Co_{0.098}Ni_{0.157}Mn_{0.529}O₂ | Not done | LiCo_{0.33}Ni_{0.33}Mn_{0.33}O₂ | Done | 3.8 | 1.2 | 91 | 24 | 91 |
| Example 8 | Li_{1.208}Co_{0.099}Ni_{0.158}Mn_{0.535}O₂ | Not done | LiCo_{0.33}Ni_{0.33}Mn_{0.33}O₂ | Done | 4.0 | 1.2 | 92 | 24 | 90 |
| Example 9 | Li_{1.20}Co_{0.10}Ni_{0.16}Mn_{0.54}O₂ | Not done | LiCo_{0.33}Ni_{0.33}Mn_{0.33}O₂ | Done | 4.2 | 1.2 | 93 | 25 | 90 |
| Example 10 | Li_{1.192}Co_{0.101}Ni_{0.162}Mn_{0.545}O₂ | Not done | LiCo_{0.33}Ni_{0.33}Mn_{0.33}O₂ | Done | 4.4 | 1.2 | 93 | 25 | 85 |
| Comparative | Li_{1.184}Co_{0.102}Ni_{0.163}Mn_{0.551}O₂ | Not done | LiCo_{0.33}Ni_{0.33}Mn_{0.33}O₂ | Done | 4.6 | 1.2 | 94 | 25 | 83 |
| Example 1 | | | | | | | | | |
| Comparative | Li_{1.175}Co_{0.103}Ni_{0.165}Mn_{0.557}O₂ | Not done | LiCo_{0.33}Ni_{0.33}Mn_{0.33}O₂ | Done | 4.8 | 1.2 | 95 | 25 | 81 |
| Example 2 | | | | | | | | | |
| Comparative | Li_{1.167}Co_{0.104}Ni_{0.167}Mn_{0.662}O₂ | Not done | LiCo_{0.33}Ni_{0.33}Mn_{0.33}O₂ | Done | 5.0 | 1.2 | 96 | 25 | 82 |
| Example 3 | | | | | | | | | |
| Comparative | Li_{1.216}Co_{0.098}Ni_{0.157}Mn_{0.529}O₂ | Not done | LiCo_{0.33}Ni_{0.33}Mn_{0.33}O₂ | Done | 3.6 | 1.3 | 91 | 24 | 84 |
| Example 4 | | | | | | | | | |
| Comparative | Li_{1.208}Co_{0.099}Ni_{0.158}Mn_{0.535}O₂ | Not done | LiCo_{0.33}Ni_{0.33}Mn_{0.33}O₂ | Done | 3.8 | 1.3 | 92 | 24 | 83 |
| Example 5 | | | | | | | | | |

TABLE 2

| | | | | | Specific | | | | |
|---|---|---|---|---|---|---|---|---|---|
| | | | | | surface | | | | |
| | | | | | area of | | | | Cycle |
| | Lithium-excess-type lithium transition | | LiMeO₂-type lithium transition | | mixed | | | | energy |
| | metal composite oxide | | metal composite oxide | | active | Content | Initial | Battery | density |
| | | Acid | | Acid | material | of S | efficiency | capacity | retention |
| | Composition | treatment | Composition | treatment | [m²/g] | [%] | [%] | [mAh] | ratio [%] |
| Comparative | Li_{1.20}Co_{0.10}Ni_{0.16}Mn_{0.54}O₂ | Not done | LiCo_{0.33}Ni_{0.33}Mn_{0.33}O₂ | Done | 4.0 | 1.3 | 93 | 24 | 82 |
| Example 6 | | | | | | | | | |
| Comparative | Li_{1.192}Co_{0.101}Ni_{0.162}Mn_{0.545}O₂ | Not done | LiCo_{0.33}Ni_{0.33}Mn_{0.33}O₂ | Done | 4.2 | 1.3 | 94 | 25 | 82 |
| Example 7 | | | | | | | | | |
| Comparative | Li_{1.184}Co_{0.102}Ni_{0.163}Mn_{0.551}O₂ | Not done | LiCo_{0.33}Ni_{0.33}Mn_{0.33}O₂ | Done | 4.4 | 1.3 | 94 | 25 | 81 |
| Example 8 | | | | | | | | | |
| Comparative | Li_{1.175}Co_{0.103}Ni_{0.165}Mn_{0.557}O₂ | Not done | LiCo_{0.33}Ni_{0.33}Mn_{0.33}O₂ | Done | 4.6 | 1.3 | 95 | 25 | 79 |
| Example 9 | | | | | | | | | |
| Comparative | Li_{1.167}Co_{0.104}Ni_{0.167}Mn_{0.662}O₂ | Not done | LiCo_{0.33}Ni_{0.33}Mn_{0.33}O₂ | Done | 4.8 | 1.3 | 95 | 25 | 78 |
| Example 10 | | | | | | | | | |
| Comparative | Li_{1.167}Co_{0.104}Ni_{0.167}Mn_{0.662}O₂ | Not done | LiCo_{0.33}Ni_{0.33}Mn_{0.33}O₂ | Not done | 3.6 | 0 | 90 | 21 | 90 |
| Example 11 | | | | | | | | | |
| Comparative | Li_{1.167}Co_{0.104}Ni_{0.167}Mn_{0.662}O₂ | Done | LiCo_{0.33}Ni_{0.33}Mn_{0.33}O₂ | Not done | 8.2 | 0.9 | 95 | 26 | 82 |
| Example 12 | | | | | | | | | |
| Comparative | Li_{1.167}Co_{0.104}Ni_{0.167}Mn_{0.662}O₂ | Done | LiCo_{0.33}Ni_{0.33}Mn_{0.33}O₂ | Done | 8.4 | 1.5 | 97 | 27 | 82 |
| Example 13 | | | | | | | | | |
| Comparative | Li_{1.167}Co_{0.104}Ni_{0.167}Mn_{0.662}O₂ | Not done | — | — | 4.0 | 0 | 90 | 22 | 85 |
| Example 14 | | | | | | | | | |
| Comparative | Li_{1.167}Co_{0.104}Ni_{0.167}Mn_{0.662}O₂ | Done | — | — | 9.0 | 1 | 96 | 27 | 81 |
| Example 15 | | | | | | | | | |
| Comparative | Li_{1.167}Co_{0.104}Ni_{0.167}Mn_{0.662}O₂ | Not done | LiCo_{0.33}Ni_{0.33}Mn_{0.33}O₂ | Done | 3.8 | 0 | 94 | 21 | 82 |
| Example 16 | | | | | | | | | |
| Comparative | Li_{1.167}Co_{0.104}Ni_{0.167}Mn_{0.662}O₂ | Not done | LiCo_{0.33}Ni_{0.33}Mn_{0.33}O₂ | Done | 3.8 | 0 | 94 | 25 | 82 |
| Example 17 | | | | | | | | | |
| Comparative | — | — | LiCo_{0.33}Ni_{0.33}Mn_{0.33}O₂ | Not done | 0.9 | 0 | 91 | 17 | 96 |
| Example 18 | | | | | | | | | |
| Comparative | — | — | LiCo_{0.33}Ni_{0.33}Mn_{0.33}O₂ | Done | 1.5 | 0.2 | 94 | 17 | 95 |
| Example 19 | | | | | | | | | |

From Tables 1 and 2, it is apparent that the mixed active materials of Examples 1 to 10 in which the lithium-excess-type lithium transition metal composite oxide is mixed with the acid-treated LiMeO₂-type lithium transition metal composite oxide (treated with sulfuric acid) to provide a mixed active material having a specific surface area of 4.4 m²/g or less and a S content of 0.2 to 1.2% by mass ensure a high initial efficiency, battery capacity and cycle energy density retention ratio.

On the other hand, in the case where the mixed active material has a specific surface area of more than 4.4 m²/g and/or a S content of more than 1.2% by mass (the degree of acid treatment of the LiMeO₂-type lithium transition metal composite oxide is high) as in Comparative Examples 1 to 10, the cycle energy density retention ratio decreases. In the case where the LiMeO₂-type lithium transition metal composite oxide is not acid-treated (the content of S is 0) as in Comparative Example 11, the initial efficiency and the battery capacity decrease. In the case where an acid-treated lithium-excess-type lithium transition metal composite oxide is used (the specific surface area is more than 4.4 m²/g) as in Comparative Examples 12, 13 and 15, the cycle energy density retention ratio decreases. In the case where the LiMeO₂-type lithium transition metal composite oxide is not contained (the content of S is 0) as in Comparative Example 14, the initial efficiency and the battery capacity decrease. In the case where the LiMeO₂-type lithium transition metal composite oxide is treated with hydrochloric acid (the content of S is 0) as in Comparative Example 16, the battery capacity and the cycle energy density retention ratio decrease. In the case where the LiMeO₂-type lithium transition metal composite oxide is treated with nitric acid (the content of S is 0) as in Comparative Example 17, the cycle energy density retention ratio decreases. In the case where a LiMeO₂-type lithium transition metal composite oxide that is not acid-treated is used, and the lithium-excess-type lithium transition metal composite oxide is not contained (the content of S is 0) as in Comparative Example 18, the initial efficiency and the battery capacity decrease. In the case where an acid-treated LiMeO₂-type lithium transition metal composite oxide is used to provide an active material having a specific surface area of 4.4 m²/g or less and a S content of 0.2 to 1.2% by mass, but the lithium-excess-type lithium transition metal composite oxide is not contained as in Comparative Example 19, the battery capacity decreases.

As described above, in the embodiment of the present invention, a lithium-excess-type lithium transition metal composite oxide is mixed with a LiMeO₂-type lithium transition metal composite oxide to provide a positive active material for a lithium secondary battery, which has a specific surface area of 4.4 m²/g or less and a S content of 0.2 to 1.2% by mass, and consequently, the effect of improving both the battery capacity and cycle performance is exhibited.

### INDUSTRIAL APPLICABILITY

The lithium secondary battery produced using the positive active material of the embodiment of the present invention, the specific surface area of which is inhibited from being increased, has both a high battery capacity and high cycle performance, and is thus useful particularly as a lithium secondary battery for hybrid cars and electric cars.

### DESCRIPTION OF REFERENCE SIGNS

100 Lithium secondary battery
101 Assembled battery
102 Battery pack

1. A mixed active material for a lithium
secondary battery, which comprises:
a lithium transition metal composite oxide having an α-NaFeO₂ structure with a transition metal (Me) including Co, Ni and Mn and the Mn/Me molar ratio being more than 0.5, and
a lithium transition metal composite oxide having an α-NaFeO₂ structure with a transition metal (Me) including Co, Ni and Mn and the Mn/Me molar ratio being more than 0 and not more than 0.5,
wherein the mixed active material has a specific surface area of 4.4 m²/g or less and a S content of 0.2 to 1.2% by mass.

2. The mixed active material for a lithium secondary battery according to claim 1, wherein S is incorporated by acid-treating the lithium transition metal composite oxide with the transition metal (Me) including Co, Ni and Mn and the Mn/Me molar ratio being more than 0 and not more than 0.5.

3. The mixed active material for a lithium secondary battery according to claim 1, wherein the mixing ratio of the lithium transition metal composite oxide with the transition metal (Me) including Co, Ni and Mn and the Mn/Me molar ratio being more than 0.5 and the lithium transition metal composite oxide with the transition metal (Me) including Co, Ni and Mn and the Mn/Me molar ratio being more than 0 and not more than 0.5 is 70:30 to 95:5.

4. The mixed active material for a lithium secondary battery according to claim 1, wherein the mixing ratio of the lithium transition metal composite oxide with the transition metal (Me) including Co, Ni and Mn and the Mn/Me molar ratio being more than 0.5 and the lithium transition metal composite oxide with the transition metal (Me) including Co, Ni and Mn and the Mn/Me molar ratio being more than 0 and not more than 0.5 is 80:20 to 90:10.

5. The mixed active material for a lithium secondary battery according to claim 1, wherein the lithium transition metal composite oxide with the transition metal (Me) including Co, Ni and Mn and the Mn/Me molar ratio being more than 0.5 has a Co/Me molar ratio (molar ratio of Co to the transition metal Me) of 0.05 to 0.40.

6. The mixed active material for a lithium secondary battery according to claim 1, wherein the lithium transition metal composite oxide with the transition metal (Me) including Co, Ni and Mn and the Mn/Me molar ratio being more than 0.5 has a Co/Me molar ratio (molar ratio of Co to the transition metal Me) of 0.10 to 0.30.

7. The mixed active material for a lithium secondary battery according to claim 1, wherein the specific surface area is 4.2 m²/g or less.

8. The mixed active material for a lithium secondary battery according to claim 1, wherein the specific surface area is 3.8 m²/g or less.

9. The mixed active material for a lithium secondary battery according to claim 1, wherein the S content is 0.2 to 1.0% by mass.

10. The mixed active material for a lithium secondary battery according to claim 1, wherein the S content is 0.2 to 0.8% by mass.

11. The mixed active material for a lithium secondary battery according to claim 1, wherein the lithium transition metal composite oxide with the transition metal (Me) including Co, Ni and Mn and the Mn/Me molar ratio being more than 0.5 has the Mn/Me molar ratio of more than 0.5 and not more than 0.8.

12. The mixed active material for a lithium secondary battery according to claim 1, wherein the lithium transition metal composite oxide with the transition metal (Me) including Co, Ni and Mn and the Mn/Me molar ratio being more than 0.5 has the Mn/Me molar ratio of more than 0.5 and not more than 0.75.

13. The mixed active material for a lithium secondary battery according to claim 1, wherein the lithium transition metal composite oxide with the transition metal (Me) including Co, Ni and Mn and the Mn/Me molar ratio being more than 0.5 has a Li/Me molar ratio (molar ratio of lithium (Li) to the transition metal) of more than 1.

14. The mixed active material for a lithium secondary battery according to claim 1, wherein the lithium transition metal composite oxide with the transition metal (Me) including Co, Ni and Mn and the Mn/Me molar ratio being more than 0.5 has a Li/Me molar ratio (molar ratio of lithium (Li) to the transition metal) of more than 1.2.

15. The mixed active material for a lithium secondary battery according to claim 1, wherein the lithium transition metal composite oxide with the transition metal (Me) including Co, Ni and Mn and the Mn/Me molar ratio being more than 0.5 has a Li/Me molar ratio (molar ratio of lithium (Li) to the transition metal) of more than 1.2 and less than 1.6.

16. The mixed active material for a lithium secondary battery according to claim 1, wherein the lithium transition metal composite oxide with the transition metal (Me) including Co, Ni and Mn and the Mn/Me molar ratio being more than 0.5 has a Li/Me molar ratio (molar ratio of lithium (Li) to the transition metal) of not less than 1.25 and not more than 1.5.

17. A lithium secondary battery electrode comprising the mixed active material for a lithium secondary battery according to claim 1.

18. A lithium secondary battery comprising the lithium secondary battery electrode according to claim 17.

19. A power storage apparatus in which the plurality of lithium secondary batteries according to claim 18 are assembled to construct the power storage apparatus.
